(19) United States
(12) Patent Application Publication
(10) Pub. No.: US 2006/0290832 A1
(43) Pub. Date: Dec. 28, 2006

(54) DISPLAY AND ELECTRONIC APPARATUS

(76) Inventors: Yu-Chuan Lin, Miaoli County (TW); Fang-Wei Chang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,422

(22) Filed: Jun. 23, 2005

(51) Int. Cl. G02F 1/1333

(52) U.S. Cl. 349/58

(57) ABSTRACT

An electronic apparatus is disclosed. The electronic apparatus includes an electronic device, a supporting base, at least a fixing member and at least a protrusion structure. The electronic device has at least a first fixing hole. The supporting base has at least one supporting rod, wherein the supporting rod has at least a second fixing hole. The fixing member is inserted through the first fixing hole and the second fixing hole. The protrusion structure is positioned on the supporting rod and is positioned between the electronic device and the supporting rod such that the center of gravity of the electronic device is shifted to substantially coincide with that of the supporting base to steadily position the electronic device on the supporting base.

### BACKGROUND OF THE INVENTION

1. Field of the Invention

The present invention relates to an electronic appliance. More particularly, the present invention relates to an electronic apparatus comprising at least a protrusion structure fixed onto at least a supporting rod of an electronic device for shifting the center of gravity of the electronic device to substantially coincide with that of a supporting base.

2. Description of Related Art

With the rapid development of the multimedia technology, the method of transmitting image data has changed from the analog type to digital type, and the size of the image device has gradually and progressively become thinner and lighter. Although the traditional cathode ray tube (CRT) display has several advantages such as excellent display quality and low cost, it also has several disadvantages such as heavy weight, larger volume, high power consumption and radiation. Accordingly, the flat panel displays are being developed with the mature semiconductor manufacturing and optoelectronic technologies for resolving the problems of the conventional CRT displays. Generally, the flat panel display can be classified into several types, namely organic electro-luminescence display (OLED), liquid crystal display (LCD) or plasma display panel (PDP).

Generally, the flat panel display apparatus can be classified into two parts including a display device and a supporting base. The display device has at least one socket, and the supporting base has at lest one supporting rod, wherein a portion of the supporting base is inserted into the socket such that supporting base steadily supports and positions the display device.

Different types of the display devices or a single display device have different centers of gravity. Furthermore, different centers of gravity may be due to different tolerances after being fabricated. Accordingly, if the supporting base with the same specification is utilized (i.e. having the same center of gravity), the center of gravity of some of display devices may not coincide with that of the supporting base and the flat panel display apparatus may be tilted and positioned unsteadily on the supporting base. Therefore, how to design the supporting base well to steadily position the flat panel display apparatus thereon has become an important subject for the manufacturers.

### SUMMARY OF THE INVENTION

Accordingly, the present invention is directed to a display apparatus comprising a display device and a supporting base, wherein the center of gravity of the display device is shifted to substantially coincide with that of the supporting base for steadily positioning the flat panel display on the supporting base.

The present invention is also directed to an electronic apparatus comprising an electronic device, wherein the center of gravity of the electronic device is shifted to substantially coincide with that of a supporting base for steadily positioning the electronic device on the supporting base.

According to an embodiment of the present invention, the display apparatus comprises a display device, a supporting base, at least a fixing member and at least a protrusion structure. The display device comprises at least a first fixing hole, and the supporting base comprises at least one supporting rod, wherein the supporting rod has at least a second fixing hole. The fixing member is inserted through the first fixing hole and the second fixing hole. In addition, the protrusion structure is disposed on the supporting rod and positioned between the display device and the supporting rod.

According to an embodiment of the present invention, protrusion structure can be integrally formed with the supporting rod. The display device further comprises at least one socket, and at least a portion of the supporting rod is inserted into the socket.

According to an embodiment of the present invention, the protrusion structure is disposed around the second fixing hole, wherein the protrusion structure comprises a spacer. The protrusion structure and the supporting rod are integrally formed. Furthermore, the fixing member comprises a screw, and the supporting base comprises a bottom base connected to the supporting rod. The supporting base comprises metal or plastic material. The display apparatus comprises organic electro-luminescence display (OLED), cathode ray tube (CRT), liquid crystal display (LCD) or plasma display panel (PDP) and the like.

According to an embodiment of the present invention, an electronic apparatus is provided. The electronic apparatus comprises an electronic device, a supporting base, at least a fixing member and at least a protrusion structure. The electronic device comprises at least a first fixing hole, and the supporting base comprises at least one supporting rod, wherein the supporting rod has at least a second fixing hole. The fixing member is inserted through the first fixing hole and the second fixing hole. Additionally, the protrusion structure is disposed on the supporting rod and positioned between the electronic device and the supporting rod.

According to an embodiment of the present invention, the protrusion structure and the supporting rod are integrally formed. The electronic device further comprises at least one socket, and at least a portion of the supporting rod is inserted into the socket.

According to an embodiment of the present invention, the protrusion structure is positioned around the second fixing hole, wherein the protrusion structure comprises a spacer. The protrusion structure and the supporting rod are integrally formed. Furthermore, the fixing member comprises a screw, and the supporting base comprises a bottom base connected to the supporting rod. And the supporting base comprises metal or plastic material.

According to an embodiment of the present invention, the protrusion structure disposed on the supporting rod is capable of shifting the center of gravity of the display device or the electronic device to substantially coincide with that of the supporting base, and therefore, the display device or the electronic device can be steadily supported by the supporting base.

### BRIEF DESCRIPTION OF THE DRAWINGS

FIG. 1A is an exploded view of a display apparatus according to one embodiment of the present invention.

FIG. 1B is a cross-sectional view of a supporting base being assembled with a display device in FIG. 1A.

FIG. 1C is a cross-sectional view of a protrusion structure according to another embodiment of the present invention.

FIG. 2A is an exploded view of a display apparatus according to one embodiment of the present invention.

FIG. 2B is a cross-sectional view of a supporting base being assembled with a display device in FIG. 2A

FIG. 3 is a side view of a multimedia horn according to one embodiment of the present invention.

FIG. 4 is a side view of an electronic apparatus according to one embodiment of the present invention.

### DESCRIPTION OF THE EMBODIMENTS

Various specific embodiments of the present invention are disclosed below, illustrating examples of various possible implementations of the concepts of the present invention. The following description is made for the purpose of illustrating the general principles of the invention and should not be taken in a limiting sense. The scope of the invention is best determined by reference to the appended claims.

In the present invention, the main aspect of the present invention is that at least a protrusion structure is disposed on the supporting rod which is then inserted into the socket of the supporting base for substantially adjusting the center of the gravity of the display device or the electronic device with that of the supporting base. Although a display apparatus and a multimedia horn are simply described as two of several examples of the present invention, it will be easily understood by those skilled in the art that the present invention can also be applied to other types of electronic devices. Therefore, the present invention is not limited to the display apparatus or the multimedia horn described herein.

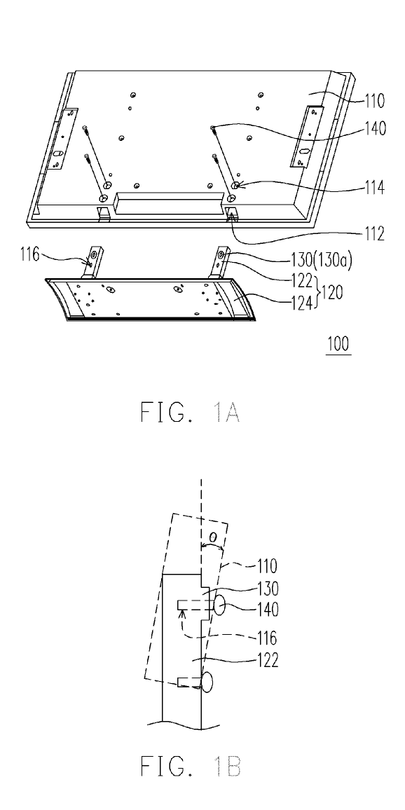

FIG. 1A is an exploded view of a display apparatus according to one embodiment of the present invention. Referring to FIG. 1A, the display apparatus 100 mainly comprises a display device 110, a supporting base 120, at least a fixing member 140 (for example, four fixing members 140 in the present embodiment) and at least a protrusion structure 130 (for example, two protrusion structures 130 in the present embodiment). For instance, the display device 110 comprises at least one socket 112 (in the present embodiment, its number is two) and the supporting base 120 mainly comprises at least one supporting rod 122 (in the present embodiment, its number is two) and a bottom base 124. According to an embodiment of the present invention, the supporting base 120 comprises metal or plastic material. Furthermore, the protrusion structure 130 is disposed on the supporting rod 122.

Referring to FIG. 1A, the protrusion structure 130 is positioned between the display device 110 and the supporting rod 122 while the display device 110 and the supporting base 120 are assembled with each other. In addition, the protrusion structure 130 is positioned in the sockets 112 after assembling the display device 110 with the supporting base 120. The fixing members 140 are such as screws. The display device 110 comprises at least one fixing hole 114 (in the present embodiment, its number is four) connected to the socket 112.

FIG. 1B is a cross-sectional view of a supporting base being assembled with a display device in FIG. 1A. Referring to FIGS. 1A and 1B, the supporting rods 122 comprise four fixing holes 116. According to an embodiment of the present invention, the protrusion structures 130 and the supporting rods 122 are integrally formed, and the protrusion structures 130 are disposed around the fixing holes 116 respectively. The display device 110 is tilted at an angleθ because of shift in its center of gravity due to the protrusion structure 130 (as shown the dotted line in FIG. 1B) assembled in the supporting base 120.

Alternatively, the protrusion structure 130 and the supporting base 122 may be separately formed, and the protrusion structures 130 may be different from the structures shown above. FIG. 1C is a cross-sectional view of a protrusion structure according to another embodiment of the present invention. Referring to FIGS. 1A and 1C, the protrusion structures 130a and the supporting base 122 are formed discrete elements, and each of the protrusion structures 130a may be formed as a spacer. The protrusion structure 130a is fixed onto the supporting rod 122 by using fixing member 140 when assembling the display device 110 and the supporting base 120. The display device 110 is tilted at an angleθ because of a shift in its center of gravity due to the protrusion structure 130a (as shown the dotted line in FIG. 1C) fixed on the supporting rod 122 and assembled in the supporting base 120.

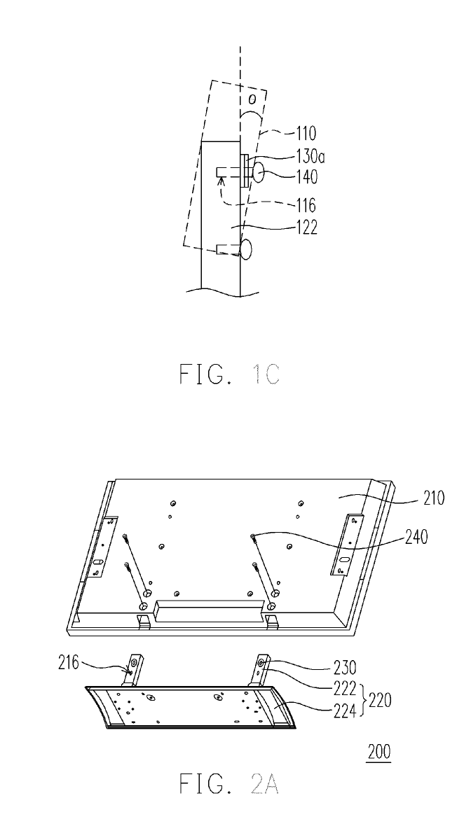

FIG. 2A is an explosive view of a display apparatus according to one embodiment of the present invention. FIG. 2B is a cross-sectional view of a supporting base being assembled with a display device in FIG. 2A. Referring to FIGS. 2A and 2B, the display apparatus 200 mainly includes a display device 210, a supporting base 220, at least a protrusion structure 230 and four fixing members 240. The supporting base 220 further comprises two supporting rods 222 and a bottom base 224, wherein the supporting rods 222 comprises four fixing holes 216. In contrast to the protrusion structure 130 and 130a being disposed around the fixing hole 115, the protrusion structure 230 is disposed above the fixing hole 216. Alternatively, the protrusion structure 230 may be disposed at other appropriate positions. Because other elements of the display apparatus 200 are similar to those of the display apparatus 100 shown in FIG. 1, therefore detailed described thereof are not repeated.

According to an embodiment of the present invention, because the protrusion structures 130, 130a (or 230) are fixed onto the inserted portions of the supporting rods 122, and therefore the center of gravity of the display device 110 (or 210) may be shifted to substantially coincide with that of the supporting base 120 (or 220) and thereby steadily position the display device 110 (or 210) on the supporting base 120 (or 220).

According to an embodiment of the present invention, the aforementioned display apparatuses 100 and 200 can be organic electro-luminescence display (OLED), cathode ray tube (CRT), liquid crystal display (LCD), plasma display panel (PDP) and the like. Furthermore, it would be easily understood by those skilled in the art that present invention is not only suitable for display apparatuses, but can also be applied to other electronic devices to achieve the purpose of the present invention. An example of which is described as follows.

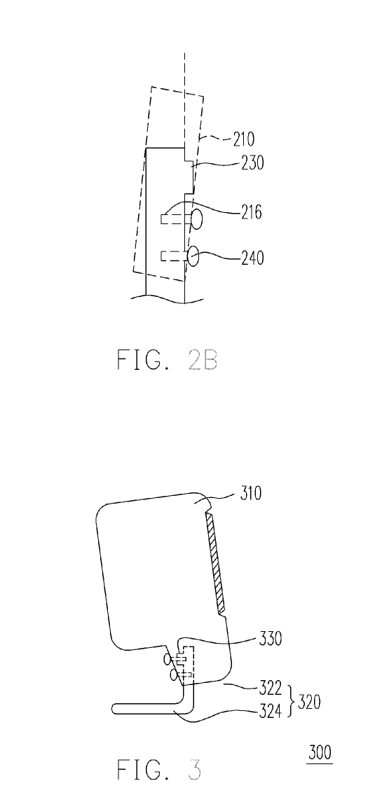

FIG. 3 is a side view of a multimedia horn according to one embodiment of the present invention. Referring to FIG. 3, the multimedia horn 300 mainly comprises a horn body 310 and a supporting base 320. The supporting base 320 further includes at least a supporting rod 322 and a bottom base 324. As described above, a protrusion structure 330 is fixed onto the supporting rod 322 for shifting the center of gravity of the horn body 310 such that the center of gravity of the horn body 310 is shifted to substantially coincide with that of the supporting base 320 to steadily position the horn body 310 on the supporting base 320.

Although the aforementioned embodiment has disclosed the electronic apparatus having at least one socket, the socket can also not be disposed on the electronic device of the present invention as followings.

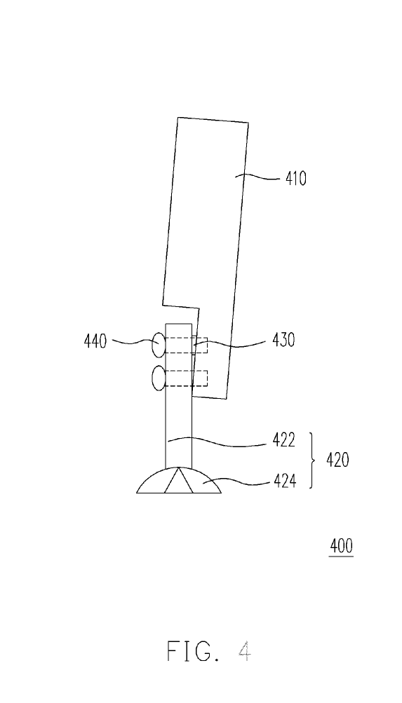

FIG. 4 is a side view of an electronic apparatus according to one embodiment of the present invention. Referring to FIG. 4, the electronic apparatus can be a display apparatus, a multimedia horn and other electronic apparatuses. The electronic apparatus 400 mainly comprises an electronic device 410 and a supporting base 420. The supporting base 420 mainly comprises a supporting rod 422 and a base 424. The main difference between the aforementioned embodiment and the present embodiment is that the supporting rod 422 and the electronic device 410 are assembled with each other by utilizing the fixing member 440 directly because no socket is designed on the electronic device 410. Because a protrusion structure 430 is installed on the supporting rod 422 for shifting the center of gravity of the electronic device 410 such that the center of gravity of the electronic device 410 is shifted to substantially coincide with that of the supporting base 420 to steadily position the electronic device 410 on the supporting base 420.

In summary, a protrusion structure, according to the present invention, is fixed onto the supporting rod of the electronic apparatus (or display apparatus) for shifting the center of gravity of the electronic device (or display device) in a manner to substantially coincide with that of the supporting base for steadily position the electronic device (or display device) on the supporting base.

The above description provides a full and complete description of the embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

What is claimed is:

1. A display apparatus, comprising:
a display device, comprising at least a first fixing hole;
a supporting base, comprising at least one supporting rod, wherein the supporting rod has at least a second fixing hole;
at least a fixing member, inserted through the first fixing hole and the second fixing hole; and
at least one protrusion structure, disposed on the supporting rod and positioned between the display device and the supporting rod.

2. The display apparatus of claim 1, wherein the protrusion structure and the supporting rod are integrally formed.

3. The display apparatus of claim 1, wherein the display device further has at least a socket, and at least a portion of the supporting rod is inserted into the socket.

4. The display apparatus of claim 1, wherein the protrusion structure is positioned around the second fixing hole.

5. The display apparatus of claim 4, wherein the protrusion structure comprises a spacer.

6. The display apparatus of claim 4, wherein the protrusion structure and the supporting rod are integrally formed.

7. The display apparatus of claim 1, wherein the fixing member comprises a screw.

8. The display apparatus of claim 1, wherein the supporting base comprises a bottom base connected to the supporting rod.

9. The display apparatus of claim 1, wherein the supporting base comprises metal or plastic material.

10. The display apparatus of claim 1, wherein the display apparatus comprises organic electro-luminescence display (OLED), cathode ray tube (CRT), liquid crystal display (LCD) or plasma display panel (PDP).

11. An electronic apparatus comprising:
an electronic device, comprising at least a first fixing hole;
a supporting base, comprising at least one supporting rod, wherein the supporting rod has at least a second fixing hole;
at least a fixing member, inserted through the first fixing hole and the second fixing hole; and
at least one protrusion structure, disposed on the supporting rod and positioned between the electronic device and the supporting rod.

12. The electronic apparatus of claim 11, wherein the protrusion structure and the supporting rod are integrally formed.

13. The electronic apparatus of claim 11, wherein the electronic device has at least a socket, and at least a portion of the supporting rod is inserted into the socket.

14. The electronic apparatus of claim 11, wherein the protrusion structure is positioned around the second fixing hole.

15. The electronic apparatus of claim 14, wherein the protrusion structure comprises a spacer.

16. The electronic apparatus of claim 14, wherein the protrusion structure and the supporting rod are integrally formed.

17. The electronic apparatus of claim 11, wherein the fixing member comprises a screw.

18. The electronic apparatus of claim 11, wherein the supporting base comprises a bottom base connected to the supporting rod.

19. The electronic apparatus of claim 11, wherein the supporting base comprises metal or plastic material.
